(19) United States
(12) Patent Application Publication
(10) Pub. No.: US 2016/0377146 A1
(43) Pub. Date: Dec. 29, 2016

(54) SHAFT ASSEMBLY FOR AN INTERNAL COMBUSTION ENGINE

(71) Applicant: GM GLOBAL TECHNOLOGY OPERATIONS LLC, Detroit, MI (US)

(72) Inventors: Fabio NUMIDI, Aglie (IT); Daniele Alberto MARCHESE, Turin (IT)

(73) Assignee: GM GLOBAL TECHNOLOGY OPERATIONS LLC, Detroit, MI (US)

(21) Appl. No.: 15/195,299

(22) Filed: Jun. 28, 2016

(30) Foreign Application Priority Data
Jun. 29, 2015 (GB) 1511403.6

(51) Int. Cl. F16F 15/26; F02B 67/04; F16C 3/18; F02F 7/00

(52) U.S. Cl. CPC F16F 15/267; F02F 7/0043; F02B 67/04; F16C 3/18

(57) ABSTRACT

A shaft assembly for an internal combustion engine includes at least one bearing journaled shaft rotatably supported in at least one bearing, and at least one bushing constrained in rotation with the shaft. The bushing is provided with a journal surface for a bearing. The shaft is made of a material different from and typically softer than the material of which the bushing is made.

### CROSS-REFERENCE TO RELATED APPLICATION

This application claims priority to Great Britain Patent Application No. 1511403.6, filed Jun. 29, 2015, which is incorporated herein by reference in its entirety.

### TECHNICAL FIELD

The present disclosure pertains to bearing journaled shafts of an internal combustion engine, in particular to the mounting of these shafts to the internal combustion engine.

### BACKGROUND

Internal combustion engines are provided with rotatable shafts. As an example, internal combustion engines are provided with a crankshaft to transform the reciprocating motion of the piston into a rotary motion, a camshaft to control the operations of engine valves, and one or more balance shafts to reduce vibrations of the internal combustion engine.

The shaft can be mounted within the internal combustion engine by means of bearings, e.g. roller or ball bearings, which allow the shaft to be bearing journaled, i.e. supported in a rotatable manner in one or more bearings. In other words, the bearings support the shaft at a journal surface, and allow rotation of the shaft with respect to the internal combustion engine.

In order to reduce vibrations, noises and friction between the shaft and the bearings, the external surface of the shaft is properly worked in order to couple directly with the movable elements of the bearing, e.g. the rollers of the roller bearings. Moreover, the movable elements (e.g. rollers) of the bearings are usually made of steel, or of a hard material (i.e. a material having high hardness). In order to allow proper operation of the bearing, the external surface of the shaft should have a certain hardness to correctly cooperate with the rollers. Typically, the shaft is made by forged steel as well. This results in a shaft that is complex to machine, and that is costly.

Moreover, a shaft made of steel, especially if provided with steel gears meshing with other gears, is particularly noisy.

### SUMMARY

The present disclosure provides a shaft for an internal combustion engine which is less expensive of the known solutions, which minimizes noises of the shaft during its operation, in particular when it is coupled to other components by means of gears. The shaft according to the present disclosure minimizes clearance and tolerances, and friction as well, of the shaft.

According to one embodiment, a shaft assembly for an internal combustion engine includes at least one bearing journaled shaft rotatably supported in at least one bearing, and at least one bushing constrained in rotation with the shaft and provided with a journal surface for a bearing. The shaft is made of a material different from the material of which the bushing constrained thereto is made. In other words, the material of the shaft has different mechanical properties with respect to the material of the bushing. As a result, according to possible embodiments the shaft and the bushings can be made by distinct materials, or the bushing and the shaft can be made starting from the same material, but undergoing for example different treatments (e.g. thermal, surface treatments, etc.). Therefore, also in the latter case, the bushing and the shaft will be provided with different mechanical properties, and thus falling within the expression “shaft made of a material different from the material of the bushing” used herein.

Advantageously, the bushing is properly configured to be correctly coupled to the bearing, for example roller or ball bearing, while the shaft can be made in the desired material, which is provided with the desired compromise between easiness of working and machining, cost-effectiveness, mechanical properties, etc. In other words, the choice of the material for the shaft is not affected by the presence of the roller bearing and the necessity of providing a journal surface for the bearing provided with the required mechanical properties to ensure a proper contact with the movable elements (e.g. rollers) of the bearing. In fact, the bushing satisfies all the requirements of the bearing and in particular can be made by a hard material suitable to provide a proper contact with the movable elements (roller or ball) of the bearing.

According to an embodiment, the shaft is made from a material that is softer than the material of the bushing. The shaft is said to be “softer” than the bushing in that the mechanical hardness of the material of the shaft is lower than the mechanical hardness of the material of the bushing. As known, the mechanical hardness is a measure of the resistance of a material to deformations. As a result, the shaft is preferably softer, and thus easier to work, than the bushing, which needs to be harder to properly cooperate with the roller bushing.

According to an embodiment, the bushing is made of steel. A steel bushing has proven to effectively cooperate with the bearing, and in particular with ball or roller bearing.

According to an embodiment, the movable elements of the bearings, e.g. balls or the rollers of the ball/roller bearing, are in contact with the journal surface of the bushing, and in particular with the external surface of the bushing. As a result, a proper coupling between the bushing and the bearing is assured.

According to an embodiment, the bushing is shrink-fit or press-fit on the shaft. This allows a quick and effective coupling of the bushing on the shaft and in particular to effectively constrain in rotation the bushing with the shaft.

According to an embodiment the shaft is a balance shaft having an eccentric portion for reducing vibration of the internal combustion engine.

The above disclosed coupling between the shaft and the bushing providing a journal surface for the bearing (e.g. roller bearing) has proven to particularly reduce noise and friction during operation of a balancer shaft of an internal combustion engine.

According to an embodiment, the movable elements of the bearing, such as the rollers of the roller bearing, are made of steel. Steel provides for the required mechanical properties for the rollers. It is particularly advantageous when steel rollers are coupled with the journal surface (external surface) of a steel bushing, so as to provide a steel-steel coupling, i.e. the steel of the rollers with the steel of the bushing.

As mentioned, the shaft can be made of any desired material different from the material of the bushing. According to an embodiment, the shaft is made of cast-iron. This provides for a good compromise between cost effectiveness and easiness of working. In particular, preferred kinds of cast iron are nodular cast-iron or grey cast-iron.

According to an embodiment the external surface of the bushing is ground and/or polished after mounting the bushing on the shaft, e.g. after the bushing has been constrained in rotation with the shaft. As a result, the axis of the shaft can be taken as a reference during grinding/polishing, and so it is possible to assure an excellent degree of concentricity between the shaft and the bushing, which is not possible if the bushing is worked before it is mounted on the shaft. With this strategy the precision of parts mating each other can be improved, allowing a better control over local radial clearances, that is beneficial for friction optimization and noise reduction. These operations are also faster and easier when the bushing is already constrained to the shaft.

According to an embodiment the shaft includes a gear made in one piece with the shaft. The gear can thus be realized with high precision. Moreover, such a gear has proven to produce less noise when coupled to another gear. It is particularly advantageous if the shaft assembly includes two shafts coupled one to the other, i.e. if a first gear in one piece with the shaft is coupled to another gear made in one piece with a further shaft.

According to an embodiment, as already mentioned above, the bearing is a roller bearing a preferably a needle roller bearing or a ball bearing. A roller bearing provides for the needed requirements of compactness, tolerances and effectiveness and benefit in friction reduction.

According to an embodiment the shaft include at least one radial protrusion configured to couple with a protrusion of the internal combustion engine, to prevent axial movements of the shaft. As mentioned, the coupling of this radial protrusion (and preferably a couple of radial protrusions) with the engine prevents axial movements of the shaft. The presence of ball bearings at the end(s) of the shaft, which were used for this purpose, can thus he avoided, as axial movements of the shaft are prevented thanks to the presence of the radial protrusion(s). Preferably the radial protrusion of the shaft is made in one piece with the shaft itself.

An embodiment of the present disclosure provides also for an internal combustion engine provided with a shaft assembly according to any of the above mentioned embodiments.

According to an embodiment, the internal combustion includes a lower crankcase, and the shaft, for example a balancer shaft is mounted in the lower crankcase.

### BRIEF DESCRIPTION OF THE DRAWINGS

The present disclosure will hereinafter be described in conjunction with the following drawing figures, wherein like numerals denote like elements.

FIG. 1 shows an embodiment of an automotive system including an internal combustion engine;

FIG. 2 is a cross-section according to the plane A-A of an internal combustion engine belonging to the automotive system of FIG. 1;

FIG. 3 is a perspective exploded view of an embodiment of a shaft assembly;

FIG. 4 is an enlarged detail of FIG. 3;

FIG. 5 is a lateral view of the shaft assembly of FIG. 3;

FIG. 6 is a sectional view of FIG. 5; and

FIG. 7 is a detail of a lateral sectional view of the shaft assembly of FIG. 3 coupled to an internal combustion engine.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description. Exemplary embodiments will now be described with reference to the enclosed drawings without intent to limit application and uses.

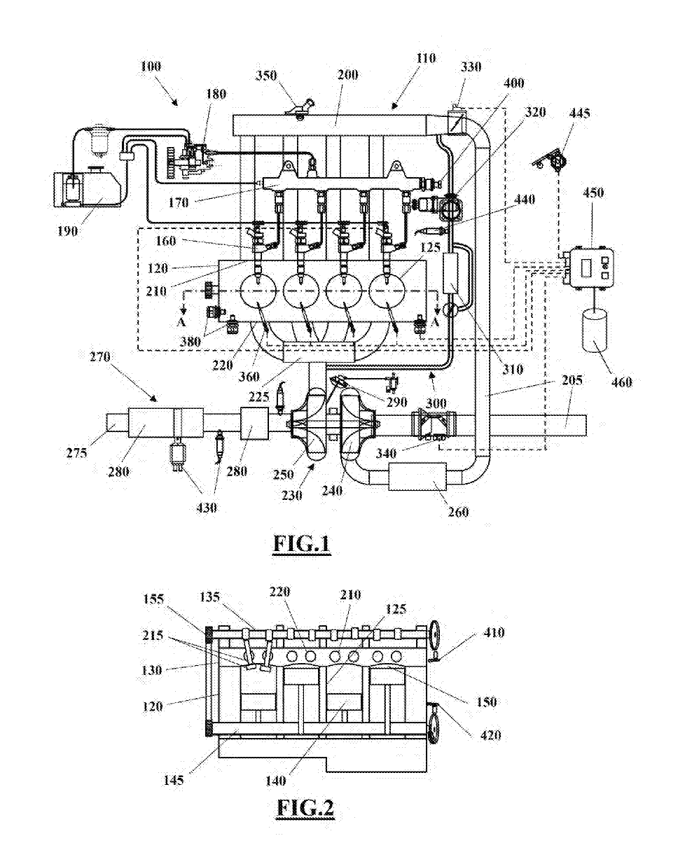

Some embodiments may include an automotive system 100, as shown in FIGS. 1 and 2, that includes an internal combustion engine (ICE) 110 having an engine block 120 defining at least one cylinder 125 having a piston 140 coupled to rotate a crankshaft 145. A cylinder head 130 cooperates with the piston 140 to define a combustion chamber 150. A fuel and air mixture (not shown) is disposed in the combustion chamber 150 and ignited, resulting in hot expanding exhaust gasses causing reciprocal movement of the piston 140. The fuel is provided by at least one fuel injector 160 and the air through at least one intake port 210. The fuel is provided at high pressure to the fuel injector 160 from a fuel rail 170 in fluid communication with a high pressure fuel pump that increase the pressure of the fuel received from a fuel source 190. Each of the cylinders 125 has at least two valves 215, actuated by the camshaft 135 rotating in time with the crankshaft 145. The valves 215 selectively allow air into the combustion chamber 150 from the port 210 and alternately allow exhaust gases to exit through a port 220. In some examples, a cam phaser 155 may selectively vary the timing between the camshaft 135 and the crankshaft 145.

The air may be distributed to the air intake port(s) 210 through an intake manifold 200. An air intake duct 205 may provide air from the ambient environment to the intake manifold 200. In other embodiments, a throttle body 330 may be provided to regulate the flow of air into the manifold 200. In still other embodiments, a forced air system such as a turbocharger 230, having a compressor 240 rotationally coupled to a turbine 250, may be provided. Rotation of the compressor 240 increases the pressure and temperature of the air in the duct 205 and manifold 200. An intercooler 260 disposed in the duct 205 may reduce the temperature of the air. The turbine 250 rotates by receiving exhaust gases from an exhaust manifold 225 that directs exhaust gases from the exhaust ports 220 and through a series of vanes prior to expansion through the turbine 250. The exhaust gases exit the turbine 250 and are directed into an exhaust system 270. This example shows a variable geometry turbine (VGT) with a VGT actuator 290 arranged to move the vanes to alter the flow of the exhaust gases through the turbine 250. In other embodiments, the turbocharger 230 may be fixed geometry and/or include a waste gate.

The exhaust system 270 may include an exhaust pipe 275 having one or more exhaust aftertreatment devices 280. The aftertreatment devices may be any device configured to change the composition of the exhaust gases. Some examples of aftertreatment devices 280 include, but are not limited to, catalytic converters (two and three way), oxidation catalysts, lean NOₓ traps, hydrocarbon adsorbers, selective catalytic reduction (SCR) systems, and particulate filters. Other embodiments may include an exhaust gas recirculation (EGR) system 300 coupled between the exhaust manifold 225 and the intake manifold 200. The EGR system 300 may include an EGR cooler 310 to reduce the temperature of the exhaust gases in the EGR system 300. An EGR valve 320 regulates a flow of exhaust gases in the EGR system 300.

The automotive system 100 may further include an electronic control unit (ECU) 450 in communication with one or more sensors and/or devices associated with the ICE 110. The ECU 450 may receive input signals from various sensors configured to generate the signals in proportion to various physical parameters associated with the ICE 110. The sensors include, but are not limited to, a mass airflow and temperature sensor 340, a manifold pressure and temperature sensor 350, a combustion pressure sensor 360, coolant and oil temperature and level sensors 380, a fuel rail pressure sensor 400, a cam position sensor 410, a crank position sensor 420, exhaust pressure and temperature sensors 430, an EGR temperature sensor 440, and an accelerator pedal position sensor 445. Furthermore, the ECU 450 may generate output signals to various control devices that are arranged to control the operation of the ICE 110, including, but not limited to, the fuel unit pump 180, fuel injectors 160, the throttle body 330, the EGR Valve 320, the VGT actuator 290, and the cam phaser 155. Note, dashed lines are used to indicate communication between the ECU 450 and the various sensors and devices, but some are omitted for clarity.

Turning now to the ECU 450, this apparatus may include a digital central processing unit (CPU) in communication with a memory system 460, or data carrier, and an interface bus. The CPU is configured to execute instructions stored as a program in the memory system, and send and receive signals to/from the interface bus. The memory system may include various storage types including optical storage, magnetic storage, solid state storage, and other non-volatile memory. The interface bus may be configured to send, receive, and modulate analog and/or digital signals to/from the various sensors and control devices.

Instead of an ECU 450, the automotive system 100 may have a different type of processor to provide the electronic logic, e.g. an embedded controller, an onboard computer, or any processing module that might be deployed in the vehicle.

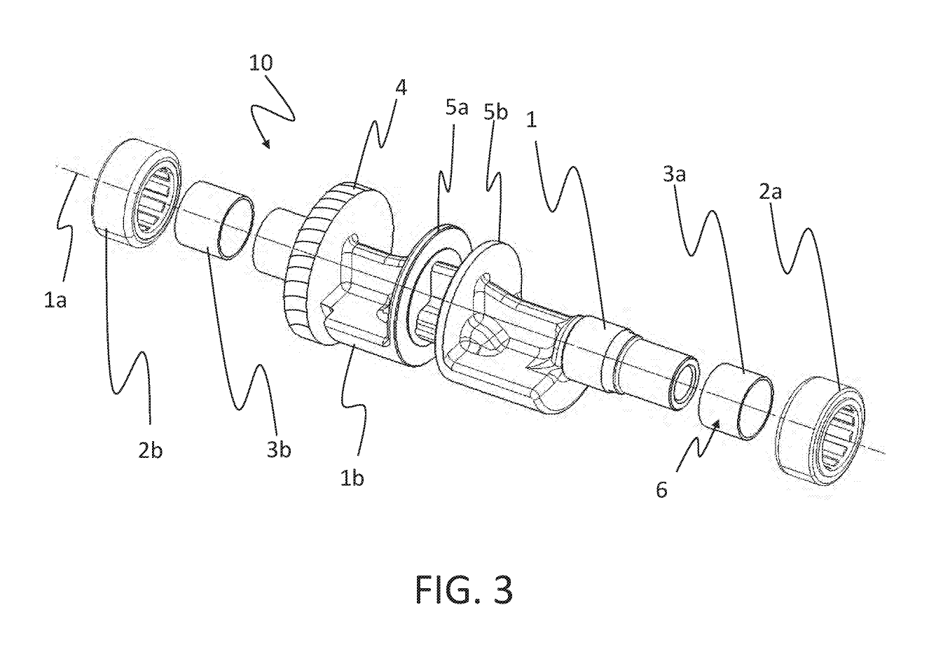

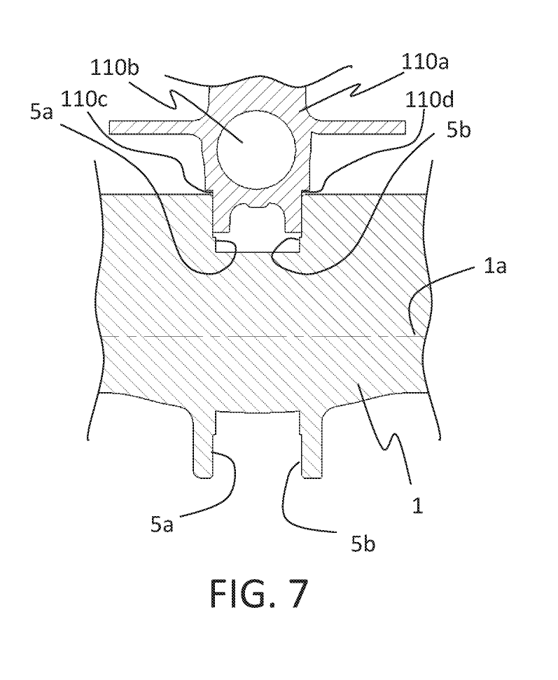

As better shown in FIGS. 3-7, a shaft assembly 10 for an internal combustion engine 110 includes a bearing journaled shaft 1 (in the following also indicated only with the term shaft), at least one roller bearing 2a, 2b and a bushing 3a, 3b interposed between each roller bearing 2a, 2b and the shaft 1.

In the shown embodiment, there are two roller bearings 2a, 2b and two bushing 3a, 3b, i.e. one bushing 3a, 3b for each roller bearing 2a, 2b. Different numbers of roller bearings and bushings may be provided in different embodiments, not shown. Ball bearings can be used as well. In particular the following description applies, mutatis mutandis, to ball bearings, too.

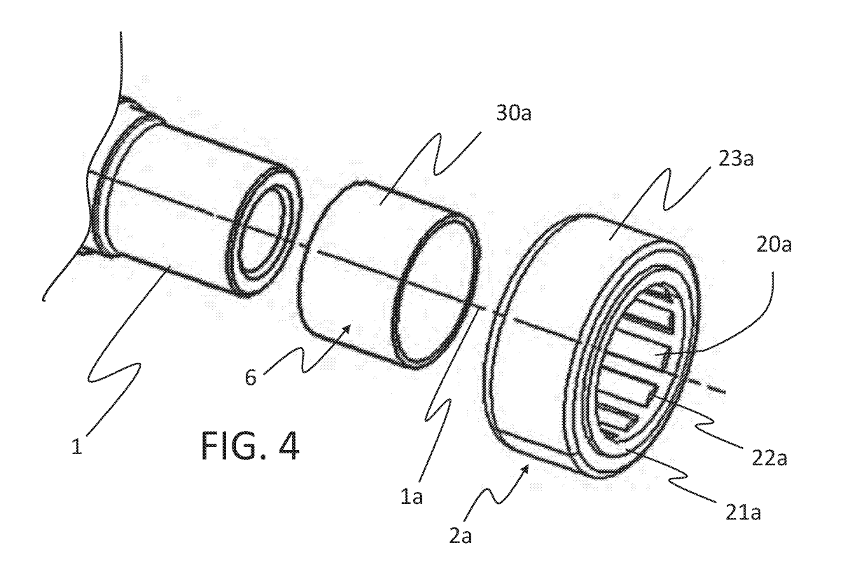

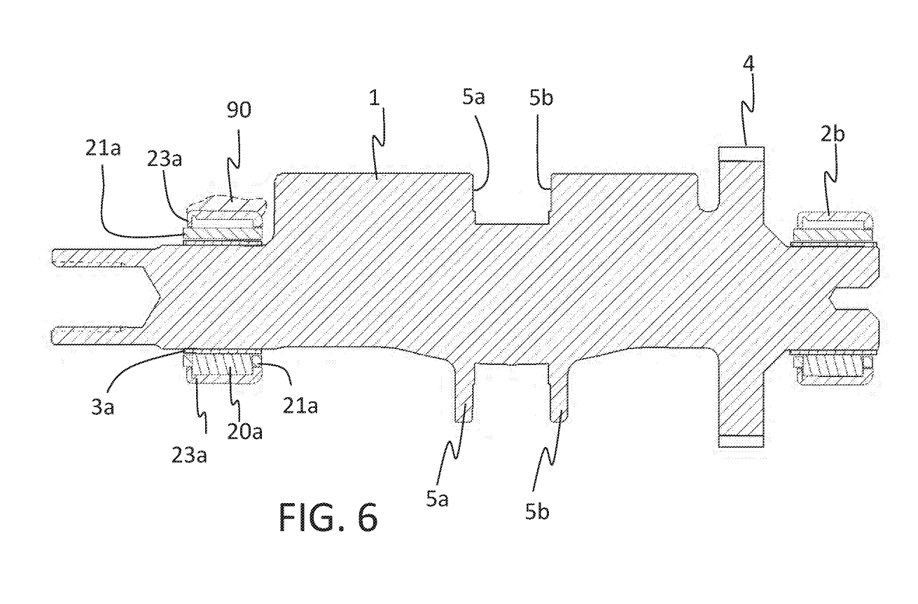

With particular reference to FIGS. 4 and 6, one roller bearing 2a and one bushing 3a will be now discussed in detail. The following description applies also to the other bushing 3b and roller bearing 2b.

The roller bearing 2a is provided with a plurality of rollers 20a. The rollers 20a are supported by a frame 21a, known also as “cage”, that arranges the rollers along a circular path. The frame 21a is substantially annular, and it is preferably provided with openings 22a. The opening 22a are provided on the internal surface of the frame 21a. The rollers 20a partially protrude from the openings 22a, in order to be coupled (arranged in contact) with the element to which the roller beating 2a is coupled, in this case the bushing 3a. In particular, the lateral surface of the rollers 20a partially protrudes from the openings 22a, so that when the roller bearing 2a is coupled to the bushing 3a, the lateral surface of the rollers 20a protruding from the openings 22a contacts the bushing 3a and in particular a journal surface 6 for the rollers 20a.

In general, the roller bearing 2a is preferably configured so that the lateral surface of the rollers 20a contacts the external surface 30a of the bushing 3a, providing a journal surface 6 for the rollers 20a. In other words, the roller bearing 2a is configured so that the rollers 20a roll on the external surface 30a of the bushing 3a, 3b.

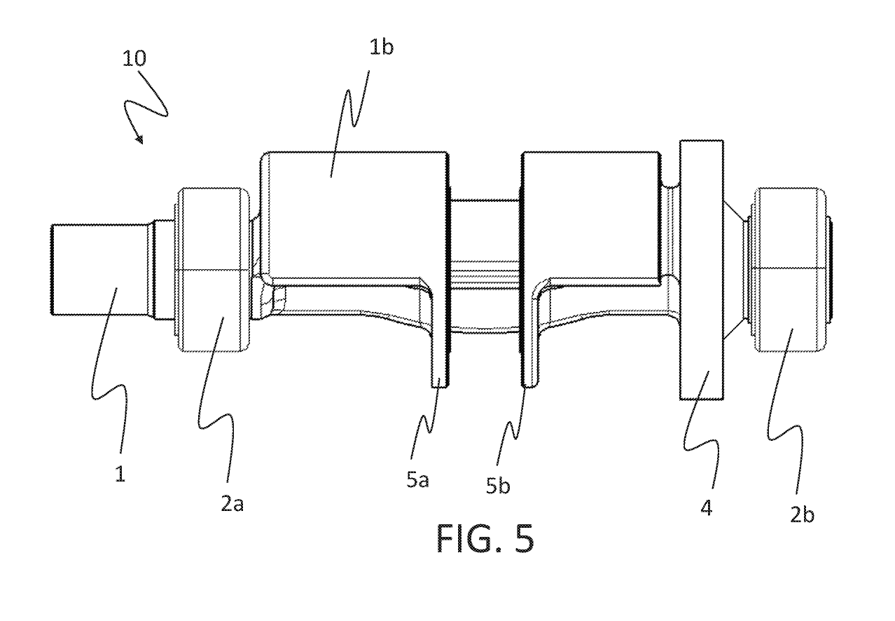

Opposite from the openings 21a, the rollers 20a may be directly coupled to the internal combustion engine 110. Alternatively, as shown in the figures, the roller bearing 20a is provided with a cylindrical case 23a, rotatably mounted to the frame 21a. The cylindrical case 23a (known also as external race or external raceway) can be coupled to the internal combustion engine 110, as shown in FIG. 5, where only a small portion of the internal combustion engine 110 (which, in the embodiment of FIG. 5, as better discussed later, is a portion of a lower crankcase 90) is shown. The roller bearings 20a are preferably made of steel. In an embodiment, the rollers 20a are shaped as cylinders, having a reduced base diameter with respect to the height. These kinds of roller bearings hare know as needle roller beatings.

The bushing 3a is a tubular element, i.e. it is shaped as a sleeve. In other words the bushing 3a is shaped as a hollow cylinder. Preferably, the bushing 3a has a reduced thickness, i.e. a thickness which is smaller than the other two dimensions of the bushing 3a. According to an embodiment, the external surface 30a of the bushing 3a receives surface finishing, in order to properly cooperate with the rollers 21a. As an example, the external surface 30a of the bushing 3a can be ground in order to assure concentricity of the bushing 3a with the shaft 1. Furthermore, the external surface 30a of the bushing 3a can be polished to reduce friction between the rollers 20a of the roller bearing 2a and the external surface 30a itself.

Preferably, these operations are carried out after that the bushing 3a is mounted onto the shaft 1. These operations can be thus done in a quick and precise manner. Moreover, the grinding/polishing operation can be carried out taking the axis 1a of the shaft 1 as a reference. As a result, it is easier to assure concentricity between the shaft 1 and the bushing 3a when the two elements are already coupled. This allows a better control over local radial clearances. The reduction of the clearances, and of their variation, helps to reduce the noise of the overall system. The bushing 3a is preferably made of steel. In particular, in a preferred embodiment, both the rollers 20a of the roller bearing 2a and the bushing 3a are made of steel.

The shaft 1 is an elongated element, having an axis 1a around which the shaft rotates during operation. The shaft 1 can have different configurations according to its function. In the shown embodiment, the shaft 1 is a balance shaft, so it is provided with an eccentric portion 1b. The rotation of the eccentric portion 1b counterbalances, in a known manner, the vibrations of the internal combustion engine 110. Preferably, the eccentric portion is made in one piece with the shaft 1.

Furthermore, an internal combustion engine 110 can be provided with two counter-rotating balance shafts 1, meshing one with the other. As a result, as in the shown embodiment, a balance shaft 1 can be provided with a gear 4. The cogs of the gear 4 are shown schematically only in FIG. 3. Preferably the gear 4 is a helical gear. In other words, the cogs of the gear are not parallel to the axis of rotation of the gear 4 (which in the shown embodiment corresponds to the axis 1a of the shaft 1), but they are angled with respect to the axis of rotation of the gear 4.

Different elements (cams, cranks, etc.) can be provided along the shaft 1 according to its function, and it can be for example a camshaft or a crankshaft of the internal combustion engine. In general, the shaft 1 is made of a material which is different from the material of the bushing 3a. As mentioned, the shaft is thus made of a material having different mechanical properties with respect to the material of the bushing. In particular, it is preferred that the shaft 1 is made of a material which is softer (i.e. that has a lower mechanical hardness) than the bushing 3a. As a result, the shaft 1 may be easy to work and to produce.

Also, the shaft 1 may be easily produced in one piece. As a result, there is no need to achieve particular tolerances between the elements of the shaft, as they are already coupled in one piece. For the same reason, vibrations between the various elements of the shaft 1 are avoided. This is particularly advantageous when the shaft 1 carries one (or more) gear 4, because vibrations between the gear 4 and the shaft 1 are avoided. Furthermore, the coupling between gears 4 made in a material of reduced hardness causes reduced noise. In preferred embodiments, the shaft 1 is made of cast-iron. Preferred kinds of this material are nodular cast-iron and grey cast-iron.

The shaft 1 and the bushing 3a, 3b are constrained in a non-rotatable manner between each other. In other words, after constraining the bushing 3a, 3b to the shaft 1, when the shaft 1 rotates, the bushing 3a, 3b rotates, too, together with the shaft 1. According to an embodiment, the bushing 3a, 3b and the shaft 1 are constrained by friction. As an example, in a first embodiment the bushing 3a, 3b is press fit onto the shaft 1. In a different embodiment, the bushing 3a, 3b is subject to a thermal treatment and it is shrink fit to the shaft 1.

As mentioned, the bushing 3a, 3b, in an embodiment, undergoes surface treatments after being constrained to the shaft 1 or also it could undergo surface treatment together with the shaft 1 after being constrained to it.

According to an embodiment, shown in detail in FIG. 6, the shaft 1 is provided with a radial protrusion 5a. The radial protrusion 5a of the shaft 1 is configured to cooperate with a surface 110c on engine protrusion 110a, in order to avoid axial movements of the shaft 1. In other words, with respect to the orientation shown in FIG. 6, the cooperation between the radial protrusion 5a and the surface 110c of the engine protrusion 110a prevents movement of the shaft 1 towards the right on axial direction.

In an embodiment, shown in the figures, the radial protrusion 5a is part of the eccentric portion 1b. More than one protrusion can be provided. As an example, in the shown embodiment, the shaft 1 is provided with two radial protrusions 5a, 5b.

The second radial protrusion 5b also cooperates with the engine protrusion 110a, in order to avoid movements of the shaft in the opposite direction that is prevented by the cooperation between the first radial protrusion 5a and the engine protrusion 110a. As an example, in the shown embodiment, the cooperation between the second radial protrusion 5b and the engine protrusion 110a prevents movement of the shaft 1 towards the left on axial direction.

In the shown embodiment, the radial protrusions 5a and 5b are configured to retain the engine protrusion 110a between the two radial protrusions 5a, 5b themselves, i.e. the radial protrusions 5a and 5b couple with two different surface 110c, 110d of the engine protrusion 110a.

In other embodiments, different radial protrusions can cooperate with different engine protrusions. In general, the radial protrusions are configured to cooperate with engine protrusions that are already provided on the internal combustion engine 110 itself. In other words, the engine protrusion 110a is preferably not machined ad hoc to cooperate with the radial protrusions 5a, 5b of the shaft 1. On the contrary, the internal combustion engine 110 is typically already provided with one or more engine protrusions 110a, and the shaft 1 is configured to cooperate with such engine protrusion(s) 110a.

In the shown embodiment, as an example, the engine protrusion 110a is the seat of an oil channel 110b. In particular, as mentioned, in the shown embodiment the shaft 1 is a balancer shaft inserted within the lower crankcase 90 of the internal combustion engine 110. As a result, the shown oil channel 110b is an oil channel of the lower crankcase 90. As known, the lower crankcase 90 is the lower portion of the housing of the crankshaft 145.

In general, there is a certain clearance between the radial protrusion 5a and the relevant surface 110c of the engine protrusion 110a because, during normal operation of the shaft 1, the radial protrusion 5a rotates around axis 1a with respect to the engine protrusion 110a. Lubrication can be provided as well, if needed, by means of a small oil drill, in order to assure the proper relative motion between the engine protrusion 110a and the shaft 1 without contrasting the rotation of the shaft 1 itself.

In an embodiment, the radial protrusion 5a is made in one piece with the shaft 1. As mentioned, in the shown embodiment, the protrusion 5a (together with the radial protrusion 5b) is part of the eccentric portion 1b, which is preferably in one piece with the shaft 1.

In use, the bushing 3a, 3b is constrained to the shaft 1, and the shaft 1 is rotatably coupled to the internal combustion engine 110 via the roller bearing 2a, 2b. After that, the shaft 1 can be rotated with respect to the internal combustion engine 110 to carry out its function.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

1-15. (canceled)

16. A shaft assembly for an internal combustion engine comprising a shaft rotatably supported in a bearing assembly, and a bushing constrained in rotation with the shaft and having a journal surface for supporting a bearing assembly on the shaft, wherein the shaft is made of a first material and the bushing is made of a second material that is different from the first material.

17. The shaft assembly according to claim 16, wherein the first material comprises a material that is softer than the second material.

18. The shaft assembly according to claim 16, wherein the bushing is shrink-fit or press-fit on the shaft.

19. The shaft according to claim 16, wherein the second material comprises steel.

20. The shaft assembly according to claim 16, wherein the first material comprises cast-iron.

21. The shaft assembly according to claim 20, wherein the first material is selected from the group consisting of nodular cast-iron or grey cast-iron.

22. The shaft assembly according to claim 16, wherein the shaft comprises a balancer shaft having an eccentric portion for reducing vibrations of the internal combustion engine.

23. The shaft assembly according to claim 16, wherein an external surface of the bushing is worked after mounting the bushing on the shaft.

24. The shaft assembly according to claim 16, wherein the shaft comprises a gear formed integrally with the shaft.

25. The shaft assembly according to claim 16, wherein the bearing assembly arranged on a journal surface of the bushing comprises a plurality of bearing elements.

26. The shaft assembly according to claim 25, wherein the bearing elements are selected from the group consisting of ball bearings or roller bearings.

27. The shaft assembly according to claim 25, wherein the bearing elements are made of steel.

28. The shaft assembly according to claim 25, wherein the bearing elements are arranged in contact with the journal surface of the bushing.

29. The shaft assembly according to claim 16, wherein the shaft comprises at least one radial protrusion configured to couple with an engine protrusion of the internal combustion engine to prevent axial movements of the shaft.

30. An internal combustion engine provided with a shaft assembly according to claim 16.

31. The internal combustion engine according to claim 30 further comprising a lower crankcase, wherein the shaft is mounted in the lower crankcase.

32. A shaft assembly for an internal combustion engine comprising:
a cast-iron shaft having a gear formed integrally thereon and a balancer shaft having an eccentric portion for reducing vibrations of the internal combustion engine;
a steel bushing shrink-fit or press-fit on the shaft and constrained in rotation therewith, the steel bushing having a journal surface, wherein an external surface of the bushing is worked after mounting the bushing on the shaft; and
a bearing assembly haying a plurality of steel bearings elements in contact with the external surface for supporting the shaft for rotation.
